(19) United States
(12) Patent Application Publication
(10) Pub. No.: US 2025/0328841 A1
(43) Pub. Date: Oct. 23, 2025

(54) ENTERPRISE OPERATION ASSISTANCE USING LARGE LANGUAGE MODELS

(71) Applicant: SAP SE, Walldorf (DE)

(72) Inventors: Junxiang Jia, Singapore (SG); Vishesh P Arora, Singapore (SG); Zeling Long, Singapore (SG); Kang Yee Lim, Singapore (SG); Gopal Jhunjhunwala, Hyderabad (IN); Zhen Shu, Singapore (SG); Sivakumar Sundaresan, Saratoga, CA (US); Anil Ranka, Cupertino, CA (US); Gayatri Gopalakrishnan, Dublin, CA (US)

(21) Appl. No.: 18/642,988

(22) Filed: Apr. 23, 2024

(51) Int. Cl. G06Q 10/0633

(52) U.S. Cl. CPC G06Q 10/0633

(57) ABSTRACT

Methods, systems, and computer-readable storage media for receiving tabular data, serializing the tabular data to provide serialized data, generating a prompt comprising a persona, a set of chain-of-thought (CoT) steps, and a thinking style, the persona being specific to an operation of the enterprise and including a natural language description of a role for executing the operation, the CoT steps defining a sequence of actions that a LLM is to perform in processing the prompt, the thinking style including a natural language description of how the LLM is to process the prompt, transmitting the prompt and serialized data to the LLM, receiving output of the LLM responsive to the prompt, and executing at least one operation using the output.

### BACKGROUND

Enterprises execute a multitude of workflows, each including a series of underlying tasks, in the performance of enterprise operations. Execution of workflows can be performed across multiple data centers, systems, and platforms. For example, workflows can be executed within and/or across an enterprise resource planning (ERP) system, a human capital management (HCM) system, and a customer relationship management (CRM) system, to name a few. Enterprises continuously seek to improve and gain efficiencies in their operations. To this end, enterprises integrate systems in the domain of so-called intelligent enterprise, which can employ artificial intelligence (AI) that can include, for example, machine learning (ML) models. For example, AI can be used for data analytics and/or automating tasks in support of enterprise operations.

### SUMMARY

Implementations of the present disclosure are directed to assisting enterprise operations using large language models (LLMs). More particularly, implementations of the present disclosure are directed to pre-processing of tabular data and prompt engineering to enable use of LLMs in enterprise operations.

In some implementations, actions include receiving tabular data, serializing the tabular data to provide serialized data, generating a prompt comprising a persona, a set of chain-of-thought (CoT) steps, and a thinking style, the persona being specific to an operation of the enterprise and including a natural language description of a role for executing the operation, the CoT steps defining a sequence of actions that a LLM is to perform in processing the prompt, the thinking style including a natural language description of how the LLM is to process the prompt, transmitting the prompt and serialized data to the LLM, receiving output of the LLM responsive to the prompt, and executing at least one operation using the output. Other implementations of this aspect include corresponding systems, apparatus, and computer programs, configured to perform the actions of the methods, encoded on computer storage devices.

These and other implementations can each optionally include one or more of the following features: the prompt further includes a set of pre-calculation steps defining calculations to be executed by the LLM on the tabular data prior to executing actions in the set of actions; the tabular data is serialized using a text template; the prompt is generated using a prompt template; the prompt enables the LLM to access one or more of an external data source and an external tool; the external tool includes a mathematics console that is executable by the LLM to perform mathematical calculations; and the prompt is provided from a set of prompts, each prompt being specific to an operation of the enterprise.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to assisting enterprise operations using large language models (LLMs). More particularly, implementations of the present disclosure are directed to pre-processing of tabular data and prompt engineering to enable use of LLMs in enterprise operations. For example, and as described in further detail herein, tabular data is pre-processed to serialize the tabular data and prompt engineering is used to inject a persona and a thinking style when prompting a LLM. Using techniques described herein, implementations of the present disclosure overcome technical challenges presented in integrating LLMs into workflows and enable LLMs to be leveraged for enterprise operations.

Implementations can include actions of receiving tabular data, serializing the tabular data to provide serialized data, generating a prompt comprising a persona, a set of chain-of-thought (CoT) steps, and a thinking style, the persona being specific to an operation of the enterprise and including a natural language description of a role for executing the operation, the CoT steps defining a sequence of actions that a LLM is to perform in processing the prompt, the thinking style including a natural language description of how the LLM is to process the prompt, transmitting the prompt and serialized data to the LLM, receiving output of the LLM responsive to the prompt, and executing at least one operation using the output.

To provide further context for implementations of the present disclosure, and as introduced above, enterprises execute a multitude of workflows, each including a series of underlying tasks, in order to perform enterprise operations. Execution of workflows can be performed across multiple data centers, systems, and platforms. For example, workflows can be executed within and/or across an enterprise resource planning (ERP) system, a human capital management (HCM) system, and a customer relationship management (CRM) system, to name a few. Enterprises continuously seek to improve and gain efficiencies in their operations. To this end, enterprises integrate systems in the domain of so-called intelligent enterprise, which can employ artificial intelligence (AI) that can include, for example, machine learning (ML) models. For example, AI can be used for data analytics and/or automating tasks in support of enterprise operations.

In the field of AI, generative AI (GAI) has recently seen an explosion in popularity. GAI can be described as including foundation models that generate content based on training data. For example, foundation models can include LLMs, which are a form of GAI that can be used to generate text and perform other functions for a variety of use cases. The increasing power and popularity of LLMs has seen enterprises seeking avenues to leverage LLMs in improving enterprise operations. However, integrating LLMs into enterprise platforms is a non-trivial task. For example, LLMs can present various technical challenges and can have disadvantages that have to be managed and that did not exist in the pre-LLM world.

For example, LLMs are known to provide inaccurate and/or misleading output, which needs to be mitigated in order to be usable for enterprise operations. As another example, LLMs are unable to comprehend structured data, such as tabular data (data stored columns and rows of tables). Consequently, LLMs are not ideal for use in tasks that require analysis of tabular data. As still another example, LLMs are trained on a relatively large body of training data that is not specific to any particular domain. As such, LLMs are generalized and are not specific to any particular domain, lacking context for enterprise-specific tasks. Further, LLMs are not able to accurately perform mathematical computations, which limits the viability of LLMs for certain tasks.

Implementations of the present disclosure are described in further detail herein with reference to an example domain and example task within the example domain. The example domain includes human experience management (HXM) (e.g., a sub-domain of HCM) and the example task includes compensation discussions between management and employees (e.g., managers and direct reports). It is contemplated, however, that implementations of the present disclosure can be realized in any appropriate domain and/or any appropriate task.

With reference to the example domain, discussions about compensation between managers and their direct reports are delicate and necessitate careful consideration. Each compensation discussion can be different and requires not only data analysis, such as job profile, compensation history, and organizational pay bands, but also mathematical computations and generating talking points to guide the discussion. Managers often need extra time to analyze various data sources and formulate appropriate talking points for each of their direct reports. Managers must thoroughly sift through data sources, identifying patterns and discrepancies, and craft talking points for each of their direct reports. Further, managers need to carefully assess the eligibility of employees for promotions. These are time- and resource-intensive tasks.

Leveraging advancements in natural language processing (NLP), particularly employing LLMs, offers a solution to overcome challenges in the example domain. LLMs provide powerful capabilities to automatically extract key points, summarization, and themes from lengthy historical data, enabling HXM to unlock valuable insights time- and resource-efficiently and at scale.

However, using LLMs to analyze employee compensation data presents its own challenges. While LLMs are trained on vast amounts of data and can generate human-like text, LLMs are absent contextual understanding, which can result in content that is factually incorrect or misleading. Specifically, lacking a comprehensive understanding of the compensation context can render LLMs unable to capture market trends and compare salaries within an industry of the enterprise. Further, LLMs are not adept at complex mathematical calculations, potentially leading to errors in reporting increments and thus unreliable quantitative metrics. Moreover, HXM harnesses extensive tabular data. As discussed above, LLMs have a restricted ability in comprehending two-dimensional tabular data, which amplifies the overall complexity and resource consumption.

In view of the above context, implementations of the present disclosure provide an LLM-based data analytics system that uses data pre-processing and prompt engineering. More particularly, implementations of the present disclosure are directed to pre-processing of tabular data and prompt engineering to enable use of LLMs in enterprise operations. For example, and as described in further detail herein, tabular data is pre-processed to serialize the tabular data and prompt engineering is used to inject a persona and a thinking style when prompting a LLM. Using techniques described herein, implementations of the present disclosure overcome technical challenges presented in integrating LLMs into workflows and enable LLMs to be leveraged for enterprise operations.

In the example domain, the LLM-based analytics system can be used for employee compensation review by combining tabular data pre-processing and prompt engineering to perform review-related tasks. Tabular data pre-processing includes tabular data serialization that provides a reduced token count, as compared to traditional approaches. This reduces the resource-consumption required by the LLM to process the data and enhances performance of the LLM by making the data more understandable for the LLM. In some examples, prompt engineering includes prompts to the LLM that inject persona and thinking style. Example prompt techniques include chain-of-thought (CoT) and reasoning-acting (ReAct).

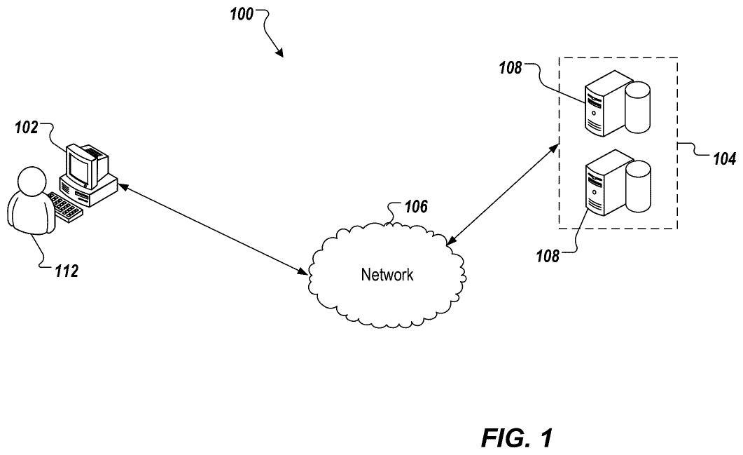

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations, and as noted above, the server system 104 can host an enterprise platform that provides computer-executable functionality to support operations of an enterprise. For example, and with non-limiting reference to the example domain, the enterprise platform can include a HCM system that provides HXM functionality. In accordance with implementations of the present disclosure, the enterprise platform leverages functionality of a LLM system that can also be hosted by the server system 104. In some examples, the LLM system is provided as a third-party system (e.g., ChatGPT provided by OpenAI). As described in further detail herein, the enterprise platform can prompt the LLM system to support operations of the enterprise.

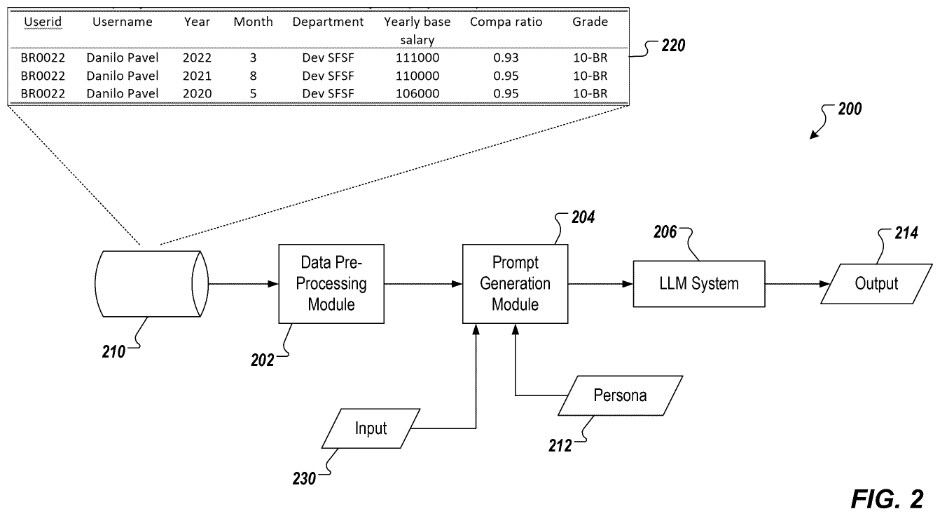

FIG. 2 depicts an example conceptual architecture 200 in accordance with implementations of the present disclosure. In the depicted example, the conceptual architecture 200 includes a data pre-processing module 202, a prompt generation module 204, a LLM system 206, and a data repository 210. As described in further detail herein, the conceptual architecture 200 is operable to execute a prompt based on data stored in the data repository 210 and a persona 212 to generate an output 214. For example, the output 214 can include data that is used in support of operations of an enterprise. In the non-limiting example context of HXM, the output 214 can include mathematical calculations, market trend data, talking points, and the like.

In further detail, the data repository 210 stores tabular data that is used for one or more operations of the enterprise. In the non-limiting example context of HXM, the tabular data can include a table 220 that records compensation history of employees of the enterprise. As introduced above, LLMs are naturally not good at understanding tabular data when incorporated into prompts. This is because, for a LLM, the relationship between column headers and corresponding cell values breaks down when read sequentially. For example, and with reference to the example of the table 220 of FIG. 2, “2021” is passed from the second row into the LLM, the LLM would not recognize that “2021” pertains to “Year.”

To overcome this limitation of LLMs, the data pre-processing module 202 serializes the tabular data to provide serialized data. Here, serializing can be described as converting the tabular data to a string of characters. The serialized data enhances the comprehensibility of the tabular data for LLMs. In some implementations, a text template is used to serialize the tabular data into the serialized data. The serialization follows the text template in a format of:
The {column name} is {cell value}.

Using the example table 220 of FIG. 2, example serialized data can include:
The Userid is BR0022. The Username is Danilo Pavel. The
Year is 2022. The Month is 3. The Department is Dev SFSF.
The Yearly base salary is 111000. The Compa ratio is 0.93.
The Grade is 10-BR.
The Userid is BR0022. The Username is Danilo Pavel. The
Year is 2021. The Month is 8. The Department is Dev SFSF.
The Yearly base salary is 110000. The Compa ratio is 0.95.
The Grade is 10-BR.
The Userid is BR0022. The Username is Danilo Pavel. The
Year is 2020. The Month is 5. The Department is Dev SFSF.
The Yearly base salary is 106000. The Compa ratio is 0.95.
The Grade is 10-BR.

By using a text template to serialize the tabular data, a reduced token count can be achieved, as compared to other methods. Here, a token can be described as a sequence of integers (e.g., in embeddings) representing elements of language, where a LLM processes language by breaking text into tokens. A token count can be described as a number of tokens that the LLM processes responsive to a prompt. Serializing using a text template in accordance with implementations of the present disclosure can reduce token counts by up to 25%, for example, as compared to other formats input to the LLM (e.g., Javascript object notation (JSON) format). In this manner, computational resources (e.g., processors, memory) are saved by reducing the burden on the LLM. For example, using JSON results in considerably more tokens that serialization of the present disclosure.

In some implementations, the prompt generation module 204 generates a prompt based on the persona 212 and the serialized data. In some examples, the prompt generation module 204 includes a set of prompt templates, each prompt template being specific to an operation of the enterprise that the LLM is to be used for. For example, and with reference to the non-limiting example task of employee compensation review (e.g., as part of a HXM operation), a prompt template can be specific to an agent of the enterprise that is to assist in the compensation review process. Similarly, the persona 212 is specific to an operation of the enterprise that the LLM is to be used for. For example, and again referencing to the non-limiting example task of employee compensation review (e.g., as part of a HXM operation), the persona 212 can be provided as compensation review assistant.

In some implementations, generation of the output 214 can be initiated by input 230 that is received from a user (e.g., the user 112 of FIG. 1). In some examples, the input 230 can indicate a task of an enterprise that output of the LLM system 206 is to be used for (e.g., compensation review). In some examples, in response to the task indicated in the input 230, the prompt generation module 204 can select a prompt template (described in further detail herein) from a set of prompt templates, the prompt template being specific to the task. In some examples, the input 230 can indicate a persona that is relevant to the task (e.g., an expert compensation analyst, a compensation assistant, a manager that is to conduct compensation discussions with an employee). In some examples, in response to the persona indicate in the input 230, the prompt generation module 204 can select a persona 212 from a set of personas, the persona 212 being descriptive of the persona of the input 230. In some examples, the input 230 can indicate data that is to be used in performance of the task. In some examples, in response to the data indicated in the input 230, the prompt generation module 204 can request the data from the data repository 210. If the data includes tabular data, the tabular data can be processed through the data pre-processing module 202 to provide serialized data that is provided to the prompt generation module 204. As described herein, the prompt generation module 204 constructs a prompt that is used to prompt the LLM system 206 to provide the output 214.

Implementations of the present disclosure provide multiple prompting techniques. Example prompting techniques include chain-of-thought (CoT) and CoT with reasoning and acting (CoT+ReACT). Listings 1 and 2 provide example prompt templates for CoT and CoT+ReACT, respectively, for the non-limiting example of employee compensation review:

LISTING 1
Example CoT Prompt Template

| | |
|---|---|
| {PERSONA} | Assume you are a compensation assistant |
| | who assists a human resources agent in |
| | explaining the compensation for an |
| | employee. |
| {DATA} | Compensation data and of the employee is |
| | provided in [serialized. data] . |
| {TASK} | Run a detailed analysis on the |
| | compensation data for the employee and |
| | identify any general discrepancies or |
| | anti-patterns in the compensation data. |
| {COT} | STEP 1: Feature extraction from the |
| | compensation data. |
| | STEP 2: Feature extraction from bonus |
| | data. |
| | STEP 3: Anomaly/pattern detection from |
| | the output of STEPS 1 and 2. |
| | STEP 4: Create actionable items from the |
| | output of STEP 3. |
| | STEP 5: Summarize the output of STEPS 3 |
| | and 4. |
| {THINKING STYLE} | Make sure you are absolutely sure about |
| | your findings. Don't just scratch the |
| | surface of the data, but make sure you |
| | really dig deep into the data and do |
| | some data processing before you give |
| | your findings. Be creative and think |
| | out-of-the-box, do not give generic |
| | statements. Make sure everything you |
| | report is tailored to the above data. |
| | Articulate your detailed findings and |
| | recommendations in a way that is |
| | understandable and actionable. |

LISTING 2
Example CoT + ReACT Prompt Template

| | |
|---|---|
| {PERSONA} | Assume you are a compensation assistant |
| | who assists a human resources agent in |
| | explaining the compensation for an |
| | employee. |
| {DATA} | Compensation data and of the employee is |
| | provided in [serialized. data] . |
| {TASK} | Run a detailed analysis on the |
| | compensation data for the employee and |
| | identify any general discrepancies or |
| | anti-patterns in the compensation data. |
| {CALCULATION} | PRE-CAL-STEP 1: |
| | Perform arithmetic calculation for |
| | compensation data. |
| | PRE-CAL-STEP 2: |
| | Perform arithmetic calculation for bonus |
| | data. |
| {COT} | STEP 1: Feature extraction from the |
| | compensation data. |
| | STEP 2: Feature extraction from bonus |
| | data. |
| | STEP 3: Anomaly/pattern detection from |
| | the output of STEPS 1 and 2. |
| | STEP 4: Create actionable items from the |
| | output of STEP 3. |
| | STEP 5: Summarize the output of STEPS 3 |
| | and 4. |
| {THINKING STYLE} | Make sure you are absolutely sure about |
| | your findings. Don't just scratch the |
| | surface of the data, but make sure you |
| | really dig deep into the data and do |
| | some data processing before you give |
| | your findings. Be creative and think |
| | out-of-the-box, do not give generic |
| | statements. Make sure everything you |
| | report is tailored to the above data. |
| | Articulate your detailed findings and |
| | recommendations in a way that is |
| | understandable and actionable. |

In accordance with implementations of the present disclosure, the persona repositions the LLM to respond from the perspective of a specified person (e.g., an expert compensation analyst, a compensation assistant, a manager that is to conduct compensation discussions with an employee). This not only enhances the ability of the LLM to manage intricate data (e.g., compensation data), but also enables the LLM to derive insightful conclusions. The thinking style enables the LLM to produce non-obvious observations, thereby enriching the analytical depth of the LLM. By instructing the LLM to engage in creative thinking, capability of the LLM to conduct in-depth data analysis is guaranteed rather than simply scratching the surface.

An important expectation for the insights derived from data analysis is the flow of logical reasoning. Implementations of the present disclosure use CoT prompting to improve reasoning ability of the LLM. CoT prompting deconstructs complex tasks into manageable and logical sub-tasks. In CoT prompting, an initial query is replaced by a sequence of intermediary logical steps (sub-tasks) articulated in natural language. For example, and as provided for in Listings 1 and 2, CoT steps define a sequence of actions that a LLM is to perform in processing the prompt. Prompting a LLM using CoT prompting improves the performance of LLMs when dealing with intricate arithmetic and reasoning tasks. This is achieved by extracting key data individually from data sources, improving arithmetic calculations by providing step-by-step guidance, and enhancing reasoning capability by furnishing detailed steps.

Implementations of the present disclosure use ReAct prompting to provide the LLM with the ability to understand external data (e.g., market trends) and accurately compute arithmetic calculations. More particularly, ReAct prompting enables the LLM to interact with one or more external tools and retrieve information that is accurate and reliable. In this manner, inaccurate and/or misleading responses from the LLM (e.g., hallucinations) can be mitigated.

An example tool can be a retriever to retrieve data from one or more external data sources. For example, an example external data source can include market data that represents market trends (e.g., compensation trends for different roles). For example, the retriever enables the LLM to access credible resources, thus mitigating the risk of generating misleading output from patterns learnt from its training data. That is, the external data sources provide accurate, up-to-date data to provide guardrails for LLM responses. In the example context of employee compensation review, augmenting context of the LLM enables the LLM to directly compare any employee's compensation data to real-time industrial trends. Another example tool includes a mathematics console (e.g., a Python console) that enables LLMs to accurately preform mathematical calculations. For example, LLMs are known for an inability to perform mathematical calculations correctly. However, with access to a mathematics console that can execute Python code, for example, accuracy of the LLM in calculations notably increases as the LLM can actively incorporate the code's response to augment its analysis.

More particularly, to execute ReAct functionality, an external tool is given along with the input prompt. In the example shown above, a CSV file reader and a Python code executor is used for reading in from an external data source and performing mathematical calculations, respectively. In addition to the tools, an instruction is also added in the prompt to make the LLM aware of the tool and task given. An example of such instruction is shown in Listing 2, where a series of pre-calculation steps are provided in the prompt. Based on the additional instructions, the LLM would follow the instructions and utilize the given tools where needed.

As described herein, the prompt as provided in accordance with implementations of the present disclosure is a data structure that addresses technical challenges posed by use of LLMs in support of operations of an enterprise. For example, the prompt, as a data structure, enhances the accuracy of output of the LLM (e.g., mitigating hallucinations, providing accurate calculations), providing context that is specific to a domain of the operation, and provides a reduced token count, as compared to other techniques, for resource-efficiencies in processing the prompt.

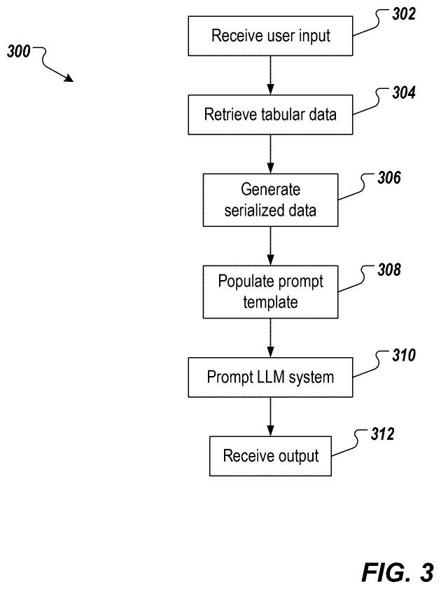

FIG. 3 depicts an example process 300 that can be executed in accordance with implementations of the present disclosure. In some examples, the example process 300 is provided using one or more computer-executable programs executed by one or more computing devices.

User input is received (302). For example, and as described herein with reference to FIG. 2, the user input 230 is received by the prompt generation module 204. Tabular data is retrieved (304) and serialized data is generated (306). For example, and as described herein, the input 230 can indicate data that is to be used in performance of the task. In some examples, in response to the data indicated in the input 230, the prompt generation module 204 can request the data from the data repository 210. If the data includes tabular data, the tabular data can be processed through the data pre-processing module 202 to provide serialized data that is provided to the prompt generation module 204.

A prompt template is populated (308). For example, and as described herein, the input 230 can indicate a task of an enterprise that output of the LLM system 206 is to be used for (e.g., compensation review). In some examples, in response to the task indicated in the input 230, the prompt generation module 204 can select a prompt template (described in further detail herein) from a set of prompt templates, the prompt template being specific to the task. In some examples, the input 230 can indicate a persona that is relevant to the task (e.g., an expert compensation analyst, a compensation assistant, a manager that is to conduct compensation discussions with an employee). In some examples, in response to the persona indicate in the input 230, the prompt generation module 204 can select a persona 212 from a set of personas, the persona 212 being descriptive of the persona of the input 230. In some examples, the prompt template is populated with the persona 212. A LLM system is prompted (310) and output is received (312). For example, and as described herein, the prompt generation module 204 constructs a prompt that is used to prompt the LLM system 206 to provide the output 214.

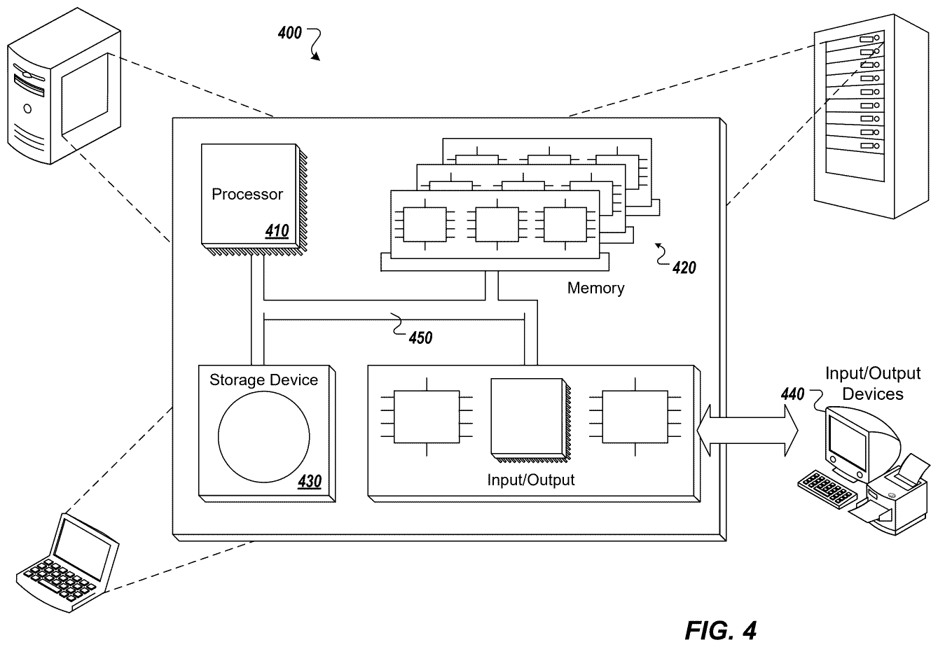

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for executing one or more operations of an enterprise using large language models (LLMs), the method being executed by one or more processors and comprising:
receiving tabular data;
serializing the tabular data to provide serialized data;
generating a prompt comprising a persona, a set of chain-of-thought (CoT) steps, and a thinking style, the persona being specific to an operation of the enterprise and comprising a natural language description of a role for executing the operation, the CoT steps defining a sequence of actions that a LLM is to perform in processing the prompt, the thinking style comprising a natural language description of how the LLM is to process the prompt;
transmitting the prompt and serialized data to the LLM;
receiving output of the LLM responsive to the prompt; and
executing at least one operation using the output.

2. The method of claim 1, wherein the prompt further comprises a set of pre-calculation steps defining calculations to be executed by the LLM on the tabular data prior to executing actions in the set of actions.

3. The method of claim 1, wherein the tabular data is serialized using a text template.

4. The method of claim 1, wherein the prompt is generated using a prompt template.

5. The method of claim 1, wherein the prompt enables the LLM to access one or more of an external data source and an external tool.

6. The method of claim 5, wherein the external tool comprises a mathematics counsel that is executable by the LLM to perform mathematical calculations.

7. The method of claim 1, wherein the prompt is provided from a set of prompts, each prompt being specific to an operation of the enterprise.

8. A non-transitory computer-readable storage medium coupled to one or more processors and having instructions stored thereon which, when executed by the one or more processors, cause the one or more processors to perform operations for executing one or more operations of an enterprise using large language models (LLMs), the operations comprising:
receiving tabular data;
serializing the tabular data to provide serialized data;
generating a prompt comprising a persona, a set of chain-of-thought (CoT) steps, and a thinking style, the persona being specific to an operation of the enterprise and comprising a natural language description of a role for executing the operation, the CoT steps defining a sequence of actions that a LLM is to perform in processing the prompt, the thinking style comprising a natural language description of how the LLM is to process the prompt;
transmitting the prompt and serialized data to the LLM;
receiving output of the LLM responsive to the prompt; and
executing at least one operation using the output.

9. The non-transitory computer-readable storage medium of claim 8, wherein the prompt further comprises a set of pre-calculation steps defining calculations to be executed by the LLM on the tabular data prior to executing actions in the set of actions.

10. The non-transitory computer-readable storage medium of claim 8, wherein the tabular data is serialized using a text template.

11. The non-transitory computer-readable storage medium of claim 8, wherein the prompt is generated using a prompt template.

12. The non-transitory computer-readable storage medium of claim 8, wherein the prompt enables the LLM to access one or more of an external data source and an external tool.

13. The non-transitory computer-readable storage medium of claim 12, wherein the external tool comprises a mathematics counsel that is executable by the LLM to perform mathematical calculations.

14. The non-transitory computer-readable storage medium of claim 8, wherein the prompt is provided from a set of prompts, each prompt being specific to an operation of the enterprise.

15. A system, comprising:
a computing device; and
a computer-readable storage device coupled to the computing device and having instructions stored thereon which, when executed by the computing device, cause the computing device to perform operations for executing one or more operations of an enterprise using large language models (LLMs), the operations comprising:
receiving tabular data;
serializing the tabular data to provide serialized data;
generating a prompt comprising a persona, a set of chain-of-thought (CoT) steps, and a thinking style, the persona being specific to an operation of the enterprise and comprising a natural language description of a role for executing the operation, the CoT steps defining a sequence of actions that a LLM is to perform in processing the prompt, the thinking style comprising a natural language description of how the LLM is to process the prompt;
transmitting the prompt and serialized data to the LLM;
receiving output of the LLM responsive to the prompt; and
executing at least one operation using the output.

16. The system of claim 15, wherein the prompt further comprises a set of pre-calculation steps defining calculations to be executed by the LLM on the tabular data prior to executing actions in the set of actions.

17. The system of claim 15, wherein the tabular data is serialized using a text template.

18. The system of claim 15, wherein the prompt is generated using a prompt template.

19. The system of claim 15, wherein the prompt enables the LLM to access one or more of an external data source and an external tool.

20. The system of claim 19, wherein the external tool comprises a mathematics counsel that is executable by the LLM to perform mathematical calculations.
